(19) United States
(12) Patent Application Publication
(10) Pub. No.: US 2021/0088841 A1
(43) Pub. Date: Mar. 25, 2021

(54) POLARIZING PLATE, CURVED LIQUID CRYSTAL DISPLAY DEVICE INCLUDING SAME, AND METHOD FOR MANUFACTURING CURVED LIQUID CRYSTAL DISPLAY DEVICE

(71) Applicant: Samsung SDI Co., Ltd., Yongin-si, Gyeonggi-do (KR)

(72) Inventors: Kwang Ho SHIN, Suwon-si (KR); Ji Hyun WI, Suwon-si (KR); Yeon Ju JUNG, Suwon-si (KR)

(21) Appl. No.: 16/096,677

(22) PCT Filed: Mar. 9, 2017
(86) PCT No.: PCT/KR2017/002571

§ 371 Date: Oct. 25, 2018

(30) Foreign Application Priority Data
Apr. 28, 2016 (KR) 10-2016-0052017

(51) Int. Cl. G02F 1/1335; B32B 27/36; B32B 27/08; G02B 1/14

(52) U.S. Cl. CPC G02F 1/133531; B32B 27/36; B32B 27/08; G02F 2201/56; G02F 1/133562; B32B 2457/202; B32B 2307/42; G02B 1/14

(57) ABSTRACT

Provided are a polarizing plate, a curved liquid crystal display device including the same, and a method for manufacturing a curved liquid crystal display device. The polarizing plate according to the present invention includes a polarizer and a polarizer protection film disposed on at least one surface of the polarizer, wherein the polarizing plate has a shrinkage rate in a machine direction (MD), which is greater by a range from about 2.2% to about 20% than that in a transverse direction (TD).

### CROSS-REFERENCE TO RELATED APPLICATION(S)

This application is a National Phase Patent Application and claims priority to and the benefit of International Application Number PCT/KR2017/002571, filed on Mar. 9, 2017, which claims priority to and the benefit of Korean Patent Application No. 10-2016-0052017, filed on Apr. 28, 2016, the entire contents of each of which are incorporated herein by reference.

### TECHNICAL FIELD

The present invention relates to a polarizing plate, a curved liquid crystal display, and a method of manufacturing the curved liquid crystal display.

### BACKGROUND

Currently, liquid crystal displays are the most widely used flat panel displays and include two substrates, in which field generating electrodes such as pixel electrodes and common electrodes are formed, and a liquid crystal layer interposed therebetween.

A liquid crystal display generates an electric field in a liquid crystal layer by applying voltage to field generating electrodes, and thus determines an alignment direction of liquid crystals of the liquid crystal layer and controls polarization of incident light, thereby displaying images.

As a liquid crystal display is used as a display of a television receiver, a screen size of the liquid crystal display increases. As such, as the size of the liquid crystal display increases, a difference in viewing angle between when a viewer watches a central portion of the screen and when the viewer watches both left and right ends of the screen can increase.

To compensate such a difference in viewing angle, a liquid crystal display may be formed in a curved shape by bending the liquid crystal display into a concave or convex shape. A curved liquid crystal display may be a portrait type, in which the curved liquid crystal display has a larger vertical length than a horizontal length and is bent in the vertical direction, or a landscape type, in which the curved liquid crystal display has a shorter vertical length than a horizontal length and is bent in the horizontal direction, based on a viewer.

### SUMMARY

It is one aspect of the present invention to provide a polarizing plate, which allows to be form a curved display panel by bending a flat display panel without a separate bending process and thus allows excellent durability to be realized by cancelling out restoring force of the curved display panel, and a curved liquid crystal display including the polarizing plate.

It is another aspect of the present invention to provide a polarizing plate, which having excellent durability, suppressing a rainbow mura, realizing naturally curved liquid crystal display and the same time preventing a reduction of optical properties, and a curved liquid crystal display including the polarizing plate.

It is another aspect of the present invention to provide a method of manufacturing the curved liquid crystal display.

The present invention is not limited to the above objects, and the above and other objects of the present invention will become apparent to those skilled in the art from the detailed description of the invention.

In accordance with one aspect of the present invention, a polarizing plate includes a polarizer and a polarizer protective film disposed on at least one surface of the polarizer, wherein the polarizing plate has machine-direction (MD) shrinkage that is greater than transverse-direction (TD) shrinkage by about 2.2% to about 20%.

The machine direction may be an absorption axis of the polarizer.

The polarizer protective film may include a polyester material.

The polarizer protective film may include polyethylene terephthalate, polyethylene naphthalate, or a copolymer including combinations thereof.

The polarizer protective film may have a triple co-extrusion structure which includes polyethylene terephthalate, polyethylene naphthalate, or a copolymer including combinations thereof.

The polarizing plate may have a machine-direction length and a transverse-direction length different from each other.

The polarizer protective film may have an in-plane retardation of about 5,000 nm to about 15,000 nm.

In accordance with another aspect of the present invention, a curved liquid crystal display includes: a curved display panel displaying images in response to an applied signal; an upper curved polarizing plate disposed on an upper side of the curved display panel; and a lower curved polarizing plate disposed on a lower side of the curved display panel, wherein machine directions (MDs) of the upper and lower curved polarizing plates are orthogonal to each other, and the upper and lower curved polarizing plates have machine-direction shrinkage that is greater than transverse-direction shrinkage by about 2.2% to about 20%.

The curved liquid crystal display may have a viewer-facing surface that is a curved surface concave with respect to the viewer.

The upper curved polarizing plate may be disposed on the viewer-facing surface with reference to the curved display panel, and may have a greater machine-direction length than a transverse-direction length.

The lower curved polarizing plate may have a greater transverse-direction length than a machine-direction length.

In accordance with a further aspect of the present invention, a method of manufacturing a curved liquid crystal display includes: preparing a flat display panel displaying images in response to an applied signal; and attaching polarizing plates such that an upper polarizing plate is attached to an upper side of the flat display panel and a lower polarizing plate is attached to a lower side of the flat display panel, wherein machine directions (MDs) of the upper and lower polarizing plates are orthogonal to each other, and the upper and lower polarizing plates have machine-direction shrinkage that is greater than transverse-direction shrinkage by about 2.2% to about 20%.

By attaching the polarizing plates, the flat display panel may be transformed into a curved display panel having a viewer-facing surface that is a curved surface concave with respect to the viewer.

In attaching the polarizing plates, the upper polarizing plate may be disposed on the viewer-facing surface with reference to the flat display panel, and may have a greater machine-direction length than a transverse-direction length.

In attaching the polarizing plates, the lower polarizing plate may be disposed on a surface opposite the surface on which the upper polarizing plate is disposed with reference to the flat display panel, and may have a greater transverse-direction length than a machine-direction length.

Details of other embodiments will be described in the detailed description with reference to the accompanying drawings.

In aspects of the present invention, provide advantageous effects as below. The present invention provides the polarizing plates, can be curved it self by having difference of a machine-direction length and a transverse-direction length from each other.

The present invention provides a polarizing plate, which allows a curved display panel to be formed by bending property of the polarizing plate it self, furthermore improve a durability of the polarizing plate and the curved liquid crystal display.

Advantageous effects described above are not limited in mentioned examples, and more various effects will be described in this application.

### BRIEF DESCRIPTION OF THE DRAWINGS

FIG. 1 is a schematic perspective view of a polarizing plate according to one embodiment of the present invention.

FIG. 2 is a sectional view of the polarizing plate of FIG. 1.

FIG. 3 is a schematic exploded perspective view illustrating a process of manufacturing a curved liquid crystal display according to one embodiment of the present invention.

FIG. 4 is a schematic exploded perspective view of a curved liquid crystal display manufactured by the process of FIG. 3 of manufacturing a curved liquid crystal display.

FIG. 5 is a sectional view of the curved liquid crystal display of FIG. 4.

### DETAILED DESCRIPTION

The advantages and features of the present invention and methods of achieving the advantages and features will become apparent from the detailed description of the following embodiments in conjunction with the accompanying drawings. However, it should be understood that the present invention is not limited to the following embodiments and may be embodied in different ways, and that the embodiments are provided for complete disclosure and thorough understanding of the invention by those skilled in the art. The scope of the present invention should be defined only by the accompanying claims and equivalents thereof.

It will be understood that, when an element or layer is referred to as being placed “on” another element or layer, it can be directly placed on the other element or layer, or intervening element(s) or layer(s) may also be present. Like components will be denoted by like reference numerals throughout the specification.

It will also be understood that, although terms such as “first”, “second” and the like may be used herein to describe various components, these components are not limited by these terms. These terms are used only to distinguish one component from another component. Therefore, a first component could be termed a second component without departing from the spirit and scope of the present invention.

In addition, it should be understood that, unless operations included in a manufacturing method described herein are specified as being sequential or consecutive or otherwise stated, one operation and another operation included in the manufacturing method should not be construed as being limited to an order described herein. Therefore, it should be understood that an order of operations included in a manufacturing method can be changed within the range of easy understanding of those skilled in the art, and that, in this case, incidental changes obvious to those skilled in the art are within the scope of the present invention.

Polarizing Plate

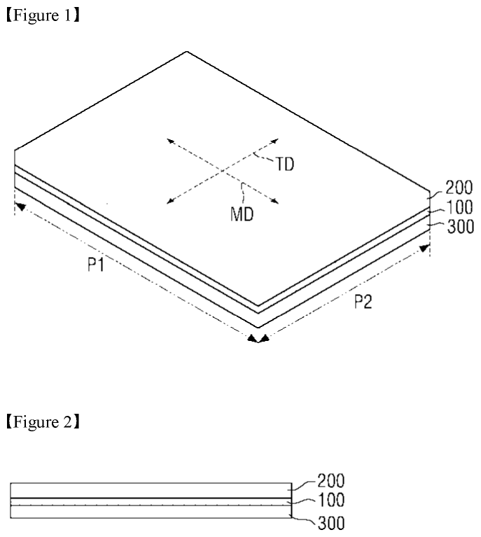

FIG. 1 is a schematic perspective view of a polarizing plate according to one embodiment of the present invention and FIG. 2 is a sectional view of the polarizing plate of FIG. 1, which is obtained by cutting the polarizing plate in a machine direction.

Hereinafter, the polarizing plate according to one embodiment of the present invention will be described with reference to FIGS. 1 and 2.

The polarizing plate according to one embodiment of the present invention includes a polarizer 100 and polarizer protective films 200, 300 disposed on at least one surface of the polarizer 100. Although the polarizer protective films 200, 300 are shown in FIGS. 1 and 2 as being disposed on both surfaces of the polarizer 100, respectively, the present invention is not limited thereto, and a polarizer protective film may be disposed only on one surface of the polarizer 100.

The polarizing plate has machine-direction (MD) shrinkage that is greater than transverse-direction (TD) shrinkage by about 2.2% to about 20%. For example, the polarizing plate may have machine-direction (MD) shrinkage that is greater than transverse-direction (TD) shrinkage by about 2.2%, 2.3%, 2.4%, 2.5%, 2.6%, 2.7%, 2.8%, 2.9%, 3.0%, 3.1%, 3.2%, 3.3%, 3.4%, 3.5%, 3.6%, 3.7%, 3.8%, 3.9%, 4.0%, 4.1%, 4.2%, 4.3%, 4.4%, 4.5%, 4.6%, 4.7%, 4.8%, 4.9%, 5.0%, 5.1%, 5.2%, 5.3%, 5.4%, 5.5%, 5.6%, 5.7%, 5.8%, 5.9%, 6.0%, 6.1%, 6.2%, 6.3%, 6.4%, 6.5%, 6.6%, 6.7%, 6.8%, 6.9%, 7.0%, 7.1%, 7.2%, 7.3%, 7.4%, 7.5%, 7.6%, 7.7%, 7.8%, 7.9%, 8.0%, 8.1%, 8.2%, 8.3%, 8.4%, 8.5%, 8.6%, 8.7%, 8.8%, 8.9%, 9.0%, 9.1%, 9.2%, 9.3%, 9.4%, 9.5%, 9.6%, 9.7%, 9.8%, 9.9%, 10.0%, 10.1%, 10.2%, 10.3%, 10.4%, 10.5%, 10.6%, 10.7%, 10.8%, 10.9%, 11.0%, 11.1%, 11.2%, 11.3%, 11.4%, 11.5%, 11.6%, 11.7%, 11.8%, 11.9%, 12.0%, 12.1%, 12.2%, 12.3%, 12.4%, 12.5%, 12.6%, 12.7%, 12.8%, 12.9%, 13.0%, 13.1%, 13.2%, 13.3%, 13.4%, 13.5%, 13.6%, 13.7%, 13.8%, 13.9%, 14.0%, 14.1%, 14.2%, 14.3%, 14.4%, 14.5%, 14.6%, 14.7%, 14.8%, 14.9%, 15.0%, 15.1%, 15.2%, 15.3%, 15.4%, 15.5%, 15.6%, 15.7%, 15.8%, 15.9%, 16.0%, 16.1%, 16.2%, 16.3%, 16.4%, 16.5%, 16.6%, 16.7%, 16.8%, 16.9%, 17.0%, 17.1%, 17.2%, 17.3%, 17.4%, 17.5%, 17.6%, 17.7%, 17.8%, 17.9%, 18.0%, 18.1%, 18.2%, 18.3%, 18.4%, 18.5%, 18.6%, 18.7%, 18.8%, 18.9%, 19.0%, 19.1%, 19.2%, 19.3%, 19.4%, 19.5%, 19.6%, 19.7%, 19.8%, 19.9%, or 20.0%. In addition, the polarizing plate may have machine-direction (MD) shrinkage that is greater than transverse-direction (TD) shrinkage by a value ranging from one of the numerical values set forth above to another numerical value set forth above. Specifically, the shrinkage difference may range from about 3% to about 18%, more specifically from about 3.6% to about 17.6%.

The machine-direction shrinkage of the polarizing plate is greater than the transverse-direction shrinkage thereof by a value in the range set forth above, whereby the polarizing plate itself can cause bending. Therefore, in the process of manufacturing a curved liquid crystal display, a curved display panel may be realized by natural bending of the polarizing plate even without a separate curved surface forming process, and may have excellent durability by cancelling out restoring force which forces the curved display panel to be restored to a flat display panel corresponding to an original shape of the curved display panel. This will be described in detail below.

The polarizer 100 may be a film capable of converting natural light or polarized light into arbitrary polarized light, generally specific linearly polarized light. The polarizer 100 may include polarizers obtained by adsorbing iodine or a dichroic material such as dichroic dyes onto a hydrophilic polymer film such as a polyvinyl alcohol film, a partially formalized polyvinyl alcohol film, or a partially saponified ethylene-vinyl acetate copolymer film, followed by stretching the hydrophilic polymer film; oriented polyene films such as products obtained by dehydration of polyvinyl alcohols and products obtained by de-hydrochloric acid treatment of polyvinyl chloride, and the like, without being limited thereto. In one embodiment, the polarizer 100 may include an iodine-containing polyvinyl alcohol film, which may have a high degree of polarization, without being limited thereto.

The machine direction may be a stretching direction of the polarizer 100, more particularly a direction of an absorption axis of the polarizer 100, that is, a direction in which iodine or a dichroic dye dyeing the polarizer 100 is aligned.

The polarizer protective films 200, 300 may include a polyester material.

The polyester material may include, for example, dicarboxylic acids such as terephthalic acid, isophthalic acid, ortho-phthalic acid, 2,5-naphthalenedicarboxylic acid, 2,6-naphthalenedicarboxylic acid, 1,4-naphthalenedicarboxylic acid, 1,5-naphthalenedicarboxylic acid, diphenyl carboxylic acid, diphenoxyethane dicarboxylic acid, diphenylsulfone carboxylic acid, anthracenedicarboxylic acid, 1,3-cyclopentanedicarboxylic acid, 1,3-cyclohexanedicarboxylic acid, 1,4-cyclohexanedicarboxylic acid, hexahydroterephthalic acid, hexahydroisophthalic acid, malonic acid, dimethylmalonic acid, succinic acid, 3,3-diethylsuccinic acid, glutaric acid, 2,2-dimethylglutaric acid, adipic acid, 2-methyladipic acid, trimethyladipic acid, pimelic acid, azelaic acid, dimer acids, sebacic acid, suberic acid, and dodecane dicarboxylic acid; and diols such as ethylene glycol, propylene glycol, hexamethylene glycol, neopentyl glycol, 1,2-cyclohexanedimethanol, 1,4-cyclohexanedimethanol, decamethylene glycol, 1,3-propanediol, 1,4-butanediol, 1,5-pentanediol, 1,6-hexanediol, 2,2-bis(4-hydroxyphenyl)propane, and bis(4-hydroxyphenyl)sulfone, without being limited thereto. The polyester material may include homopolymers obtained by polycondensation of one of the materials as set forth above, copolymers obtained by polycondensation of at least one dicarboxylic acid and at least two diols, copolymers obtained by polycondensation of at least two dicarboxylic acids and at least one diol, and polyester resins obtained by blending at least two of these homopolymers and copolymers.

In one embodiment, the polyester material may include aromatic polyesters, whereby the polyester material exhibits crystallinity, for example, polyethylene terephthalate (PET), polyethylene naphthalate (PEN), or a copolymer including combinations thereof, without being limited thereto.

In addition, the polarizer protective films 200, 300 may have a triple co-extrusion structure which includes polyethylene terephthalate, polyethylene naphthalate, or a copolymer including combinations thereof.

A polyester film may be obtained, for example, by a method in which a polyester resin as set forth above is melt-extruded in a film shape and then cooled and solidified using a casting drum to form a film. According to the present invention, a stretched polyester film, specifically a biaxially stretched polyester film, may be appropriately used in that the properties as set forth above are achieved by imparting crystallinity to the polyester film. In addition, when the polarizer protective film is mainly composed of an aromatic polyester resin as a main component, the film may further include resins other than the aromatic polyester resin, additives, and the like.

The components constituting the polarizer protective films 200, 300 as set forth above may improve durability of the polarizing plate.

When the polarizer protective films 200, 300 are stretched films, a stretching method is not particularly limited and may include longitudinal uniaxial stretching, transverse uniaxial stretching, longitudinal-transverse successive biaxial stretching, longitudinal-transverse simultaneous biaxial stretching, and the like. In one embodiment, the stretching method may be simultaneous biaxial stretching, without being limited thereto. A stretching means may include any appropriate stretching machines such as roll stretching machines, tenter stretching machines, and pantograph-type or linear motor-type biaxial stretching machines.

For example, the polarizer protective films 200, 300 may be stretched about 3.0 times to about 8.0 times or about 4.0 times to about 5.0 times in the transverse direction using a tenter stretching machine, and then naturally stretched about 1.0 time to about 5.0 times or about 1.1 times in the machine direction by a group of rolls having different rolling speeds, without being limited thereto. In this manner, the polarizer protective films 200, 300, and furthermore, the polarizing plate including the polarizer protective films 200, 300 may have a difference between the machine-direction and the transverse-direction shrinkages.

The polarizing plate may have a machine-direction length P1 and a transverse-direction length P2 which are different from each other. That is, as shown in FIG. 1, the machine-direction length P1 may be greater than the transverse-direction length P2, or conversely, the machine-direction length P1 may be less than the transverse-direction length P2. As such, the machine-direction length is different from the transverse-direction length, whereby, when applied to both surfaces of a flat display panel described below, the polarizing plate may spontaneously cause bending of the flat display panel to make the flat display panel into a curved display panel, and may cancel out restoring force of the curved display panel in a manufactured curved liquid crystal display. This will be described in detail below.

In addition, the polarizer protective films 200, 300 may have an in-plane retardation (Re) of about 5,000 nm, 6,000 nm, 7,000 nm, 8,000 nm, 9,000 nm, 10,000 nm, 11,000 nm, 12,000 nm, 13,000 nm, 14,000 nm, or 15,000 nm. Further, the polarizer protective films 200, 300 may have an in-plane retardation (Re) ranging from one of the numerical values set forth above to another numerical value set forth above. Specifically, the polarizer protective films 200, 300 may have an in-plane retardation (Re) of about 5,000 nm to about 15,000 nm, for example, about 6,000 nm to about 12,000 nm. Within this range, generation of rainbow mura can be prevented.

Although not shown, a bonding layer may be interposed between the polarizer 100 and the polarizer protective films 200, 300 for lamination thereof. The bonding layer may include a water-based bonding agent, without being limited thereto, and a UV curable bonding agent.

The water-based bonding agent may include at least one selected from the group consisting of polyvinyl alcohol resins and vinyl acetate resins, or include a hydroxyl group-containing polyvinyl alcohol resin, without being limited thereto.

In addition, the UV curable bonding agent may include an acrylic compound, for example, an acrylic, urethane-acrylic, or epoxy compound, without being limited thereto.

In another embodiment, although not shown in the drawings, a functional layer may be disposed on one surface of the polarizer protective films, and includes at least one of a hard-coating layer, an anti-reflective layer, an anti-glare layer, and a diffusion layer, preferably a hard-coating layer.

For example, the hard-coating layer may improve moist heat durability of the polarizing plate and prevent dimensional change of the polarizing plate, the anti-reflective layer may reduce reflection by extinguishing light incident from outside the polarizing plate, and the anti-glare layer may prevent glare by inducing diffusion and reflection of light incident from outside the polarizing plate.

In a further embodiment, the polarizer protective film may be laminated onto only one surface of the polarizer via the bonding layer, and an adhesive layer may be disposed on the other surface via a primer layer. The adhesive layer may be used to attach the polarizing plate to a display panel, and the primer layer may be used to protect the polarizer and improve adhesion between the polarizing plate and the display panel. The primer layer may be formed by coating a coating liquid including a water-dispersible polymer resin, water-dispersible fine particles and water onto the polarizer by bar coating, gravure coating, or the like, followed by drying the coating liquid.

Method of Manufacturing Curved Liquid Crystal Display

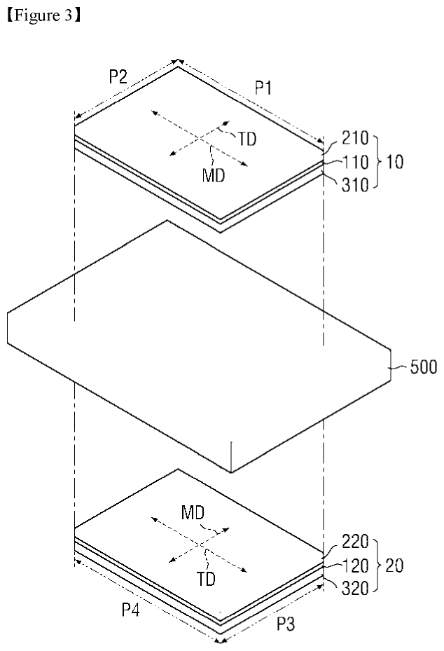

It is another aspect of the present invention to provide a method of manufacturing a curved liquid crystal display including the polarizing plate as set forth above, and FIG. 3 is a schematic exploded perspective view illustrating a process of manufacturing a curved liquid crystal display according to one embodiment of the present invention.

Referring to FIG. 3, the method of manufacturing a curved liquid crystal display includes: preparing a flat display panel 500 displaying images in response to an applied signal; and attaching polarizing plates such that an upper polarizing plate 10 is attached to an upper side of the flat display panel 500 and a lower polarizing plate 20 is attached to a lower side of the flat display panel 500. Machine directions (MDs) of the upper polarizing plate 10 and the lower polarizing plate 20 are orthogonal to each other, and the upper polarizing plate 10 and the lower polarizing plate 20 have machine-direction shrinkage that is greater than transverse-direction shrinkage by 2.2% to 20%. For example, the upper polarizing plate 10 and the lower polarizing plate 20 may have machine-direction shrinkage that is greater than transverse-direction shrinkage by about 2.2%, 2.3%, 2.4%, 2.5%, 2.6%, 2.7%, 2.8%, 2.9%, 3.0%, 3.1%, 3.2%, 3.3%, 3.4%, 3.5%, 3.6%, 3.7%, 3.8%, 3.9%, 4.0%, 4.1%, 4.2%, 4.3%, 4.4%, 4.5%, 4.6%, 4.7%, 4.8%, 4.9%, 5.0%, 5.1%, 5.2%, 5.3%, 5.4%, 5.5%, 5.6%, 5.7%, 5.8%, 5.9%, 6.0%, 6.1%, 6.2%, 6.3%, 6.4%, 6.5%, 6.6%, 6.7%, 6.8%, 6.9%, 7.0%, 7.1%, 7.2%, 7.3%, 7.4%, 7.5%, 7.6%, 7.7%, 7.8%, 7.9%, 8.0%, 8.1%, 8.2%, 8.3%, 8.4%, 8.5%, 8.6%, 8.7%, 8.8%, 8.9%, 9.0%, 9.1%, 9.2%, 9.3%, 9.4%, 9.5%, 9.6%, 9.7%, 9.8%, 9.9%, 10.0%, 10.1%, 10.2%, 10.3%, 10.4%, 10.5%, 10.6%, 10.7%, 10.8%, 10.9%, 11.0%, 11.1%, 11.2%, 11.3%, 11.4%, 11.5%, 11.6%, 11.7%, 11.8%, 11.9%, 12.0%, 12.1%, 12.2%, 12.3%, 12.4%, 12.5%, 12.6%, 12.7%, 12.8%, 12.9%, 13.0%, 13.1%, 13.2%, 13.3%, 13.4%, 13.5%, 13.6%, 13.7%, 13.8%, 13.9%, 14.0%, 14.1%, 14.2%, 14.3%, 14.4%, 14.5%, 14.6%, 14.7%, 14.8%, 14.9%, 15.0%, 15.1%, 15.2%, 15.3%, 15.4%, 15.5%, 15.6%, 15.7%, 15.8%, 15.9%, 16.0%, 16.1%, 16.2%, 16.3%, 16.4%, 16.5%, 16.6%, 16.7%, 16.8%, 16.9%, 17.0%, 17.1%, 17.2%, 17.3%, 17.4%, 17.5%, 17.6%, 17.7%, 17.8%, 17.9%, 18.0%, 18.1%, 18.2%, 18.3%, 18.4%, 18.5%, 18.6%, 18.7%, 18.8%, 18.9%, 19.0%, 19.1%, 19.2%, 19.3%, 19.4%, 19.5%, 19.6%, 19.7%, 19.8%, 19.9%, or 20.0%. In addition, the upper polarizing plate 10 and the lower polarizing plate 20 may have machine-direction shrinkage that is greater than transverse-direction shrinkage by a value ranging from one of the numerical values set forth above to another numerical value set forth above.

The upper polarizing plate 10 may include polarizer protective films 210, 310 disposed on both surfaces of a polarizer 110, respectively, and the lower polarizing plate 20 may include polarizer protective films 220, 320 disposed on both surfaces of a polarizer 120, respectively. In addition, although not shown, an adhesive layer may be interposed between the flat display panel 500 and each of the polarizing plates 10, 20 to attach the upper polarizing plate 10 and the lower polarizing plate 20 to the flat display panel 500.

By attaching the polarizing plates, the flat display panel may be transformed into a curved display panel having a viewer-facing surface that is a curved surface concave with respect to the viewer. More specifically, in attaching the polarizing plates, the upper polarizing plate 10 may be disposed on the viewer-facing surface with reference to the flat display panel 500, and the lower polarizing plate 20 may be disposed on a surface opposite to the surface on which the upper polarizing plate 10 is disposed. The flat display panel 500 may be naturally bent by the difference between the machine direction (MD) and transverse direction (TD) shrinkages of the upper polarizing plate 10 and the lower polarizing plate 20.

More specifically, the upper polarizing plate 10 may have a machine-direction length P1 that is greater than a transverse-direction length P2, and the lower polarizing plate 20 may have a transverse-direction length P4 that is greater than a machine-direction length P3. In other words, the machine direction (MD) and the transverse direction (TD) of the upper polarizing plate 10 may be orthogonal to the machine direction (MD) and the transverse direction (TD) of the lower polarizing plate 20, respectively, and the polarizing plates may have a rectangular shape and may substantially completely overlap each other.

Therefore, since the upper polarizing plate 10 has a longer length in the machine direction allowing greater shrinkage force and the lower polarizing plate 20 has a shorter length in the machine direction allowing greater shrinkage force, force due to interaction between the two polarizing plates is concentrated in a direction allowing a central portion of the upper polarizing plate 10 to be curved. When the upper polarizing plate 10 is defined as a visible side of a viewer, the flat display panel 500 may be curved such that the central portion of the upper polarizing plate 10 is indented by force due to interaction, as a result.

Typically, to manufacture a curved display panel, a process such as applying separate force to a flat display panel or bending the flat display panel has been performed. In this case, there is a problem of a complicated manufacturing process since a separate process for manufacturing a curved display panel is needed, and a curved display panel manufactured by such a method has a problem in that the curved display panel exhibits deteriorated durability or may not maintain a curved shape thereof due to restoring force which forces the curved display panel to be restored to a flat display panel. According to the present invention, the difference between the machine-direction and transverse-direction shrinkages of the polarizing plates is used, whereby a separate curved surface forming process is not required, and restoring force which forces the curved display panel to be restored to a flat display panel may be canceled out.

Although the surface of the curved display panel facing the viewer is illustrated as being a concave curved surface in the above embodiment, it should be understood that the present invention is not limited thereto. Contrary to the embodiment set forth above, in order to allow the surface of the curved display panel facing the viewer to be a convex curved surface, the upper polarizing plate may have a machine-direction length that is less than a transverse-direction length, and the lower polarizing plate may have a transverse-direction length that is less than a machine-direction length. That is, the curved display panel manufactured by arranging the polarizing plates in an opposite manner to the embodiment set forth above may have the viewer-facing surface, the surface being convex with respect to the viewer.

Curved Liquid Crystal Display

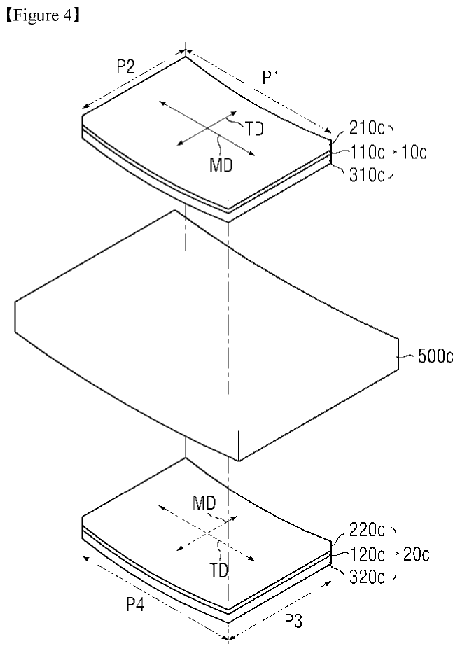

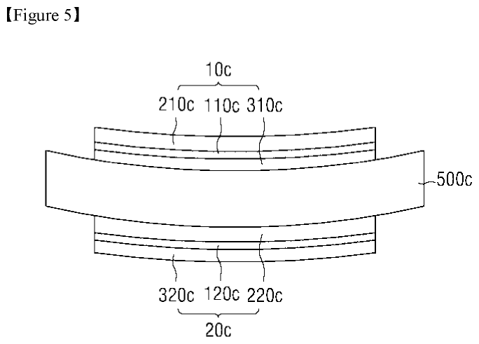

It is a further aspect of the present invention to provide a curved liquid crystal display manufactured by the method of manufacturing a curved liquid crystal display as set forth above, FIG. 4 is a schematic exploded perspective view of a curved liquid crystal display manufactured by the manufacturing method of FIG. 3, and FIG. 5 is a sectional view of the curved liquid crystal display of FIG. 4.

Referring to FIGS. 4 and 5, the curved liquid crystal display includes: a curved display panel 500C displaying images in response to an applied signal; an upper curved polarizing plate 10C disposed on an upper side of the curved display panel 500C; and a lower curved polarizing plate 20C disposed on a lower side of the curved display panel 500C, wherein machine directions (MDs) of the upper curved polarizing plate 10C and the lower curved polarizing plate 20C are orthogonal to each other, and the upper curved polarizing plate 10C and the lower curved polarizing plate 20C have machine-direction shrinkage that is greater than transverse-direction shrinkage by about 2.2% to about 20%. For example, the upper curved polarizing plate 10C and the lower curved polarizing plate 20C may have machine-direction shrinkage that is greater than transverse-direction shrinkage by about 2.2%, 2.3%, 2.4%, 2.5%, 2.6%, 2.7%, 2.8%, 2.9%, 3.0%, 3.1%, 3.2%, 3.3%, 3.4%,3.5%, 3.6%, 3.7%, 3.8%, 3.9%, 4.0%, 4.1%, 4.2%, 4.3%, 4.4%, 4.5%, 4.6%, 4.7%, 4.8%, 4.9%, 5.0%, 5.1%, 5.2%, 5.3%, 5.4%, 5.5%, 5.6%, 5.7%, 5.8%, 5.9%, 6.0%, 6.1%, 6.2%, 6.3%, 6.4%, 6.5%, 6.6%, 6.7%, 6.8%, 6.9%, 7.0%, 7.1%, 7.2%, 7.3%, 7.4%, 7.5%, 7.6%, 7.7%, 7.8%, 7.9%, 8.0%, 8.1%, 8.2%, 8.3%, 8.4%, 8.5%, 8.6%, 8.7%, 8.8%, 8.9%, 9.0%, 9.1%, 9.2%, 9.3%, 9.4%, 9.5%, 9.6%, 9.7%, 9.8%, 9.9%, 10.0%, 10.1%, 10.2%, 10.3%, 10.4%, 10.5%, 10.6%, 10.7%, 10.8%, 10.9%, 11.0%, 11.1%, 11.2%, 11.3%, 11.4%, 11.5%, 11.6%, 11.7%, 11.8%, 11.9%, 12.0%, 12.1%, 12.2%, 12.3%, 12.4%, 12.5%, 12.6%, 12.7%, 12.8%, 12.9%, 13.0%, 13.1%, 13.2%, 13.3%, 13.4%, 13.5%, 13.6%, 13.7%, 13.8%, 13.9%, 14.0%, 14.1%, 14.2%, 14.3%, 14.4%, 14.5%, 14.6%, 14.7%, 14.8%, 14.9%, 15.0%, 15.1%, 15.2%, 15.3%, 15.4%, 15.5%, 15.6%, 15.7%, 15.8%, 15.9%, 16.0%, 16.1%, 16.2%, 16.3%, 16.4%, 16.5%, 16.6%, 16.7%, 16.8%, 16.9%, 17.0%, 17.1%, 17.2%, 17.3%, 17.4%, 17.5%, 17.6%, 17.7%, 17.8%, 17.9%, 18.0%, 18.1%, 18.2%, 18.3%, 18.4%, 18.5%, 18.6%, 18.7%, 18.8%, 18.9%, 19.0%, 19.1%, 19.2%, 19.3%, 19.4%, 19.5%, 19.6%, 19.7%, 19.8%, 19.9%, or 20.0%. In addition, the upper curved polarizing plate 10C and the lower curved polarizing plate 20C may have machine-direction shrinkage that is greater than transverse-direction shrinkage by a value ranging from one of the numerical values set forth above to another numerical value set forth above.

As described above as to the method of manufacturing a curved liquid crystal display, the upper curved polarizing plate 10C and the lower curved polarizing plate 20C have machine-direction shrinkage that is greater than transverse-direction shrinkage by about 2.2% to about 20% in plan view, and the machine direction (MD) and the transverse direction (TD) of the upper curved polarizing plate 10C may be orthogonal to the machine direction (MD) and the transverse direction (TD) of the lower curved polarizing plate 20C, respectively. The polarizing plates that have been flat plates may be formed into concave polarizing plates with respect to a viewer by the shrinkage difference as set forth above. That is, all of the upper curved polarizing plate 10C, the lower curved polarizing plate 20C and the curved display panel 500C may have a viewer-facing surface that is a curved surface concave with respect to the viewer. As a result, a difference in viewing angle of the viewer can be compensated.

The upper curved polarizing plate 10C may be disposed on the viewer-facing surface with reference to the curved display panel 500C and may have a machine-direction length P1 that is greater than a transverse-direction length P2. In addition, the lower curved polarizing plate 20C may have a transverse-direction length P4 that is greater than a machine-direction length P3. In other words, when the machine direction of the upper curved polarizing plate 10C is defined as a horizontal direction, the upper curved polarizing plate 10C has a horizontal length greater than a vertical length, and the lower curved polarizing plate 20C has substantially the same planar shape as the upper curved polarizing plate 10C, whereby the upper curved polarizing plate 10C and the lower curved polarizing plate 20C may substantially completely overlap each other.

Therefore, due to the shrinkage difference as set forth above, the shrinkage in the machine direction of the upper curved polarizing plate 10C may be greater than the shrinkage in the machine direction of the lower curved polarizing plate 20C, which is orthogonal to the machine direction of the upper curved polarizing plate 10C, thereby allowing the viewer-facing surface to have a concave shape. That is, due to the difference between the machine-direction and transverse-direction shrinkages and the difference between the machine-direction and transverse-direction lengths, the machine-direction shrinkage of the upper curved polarizing plate 10C strongly acts on the display panel that has been a flat panel, thereby realizing the curved display panel 500C having a concave shape. In addition, even in a state in which the curved display panel 500C has been realized, shrinkage force acts to allow the curved display panel 500C and other devices to maintain shapes thereof.

The upper curved polarizing plate 10C and the lower curved polarizing plate 20C may have a degree of polarization of about 99.99% or more and a color ratio (CR) of 5,000 or more. With the above range of shrinkage difference, it is possible to realize a curved surface while securing a high degree of polarization and a high color ratio.

In addition, the upper curved polarizing plate 10C, the lower curved polarizing plate 20C, and the curved display panel 500C therebetween may have a radius of curvature of about 2,000 mm, 2,100 mm, 2,200 mm, 2,300 mm, 2,400 mm, 2,500 mm, 2,600 mm, 2,700 mm, 2,800 mm, 2,900 mm, 3,000 mm, 3,100 mm, 3,200 mm, 3,300 mm, 3,400 mm, 3,500 mm, 3,600 mm, 3,700 mm, 3,800 mm, 3,900 mm, 4,000 mm, 4,100 mm, 4,200 mm, 4,300 mm, 4,400 mm, 4,500 mm, 4,600 mm, 4,700 mm, 4,800 mm, 4,900 mm, 5,000 mm, 5,100 mm, 5,200 mm, 5,300 mm, 5,400 mm, 5,500 mm, 5,600 mm, 5,700 mm, 5,800 mm, 5,900 mm, or 6,000 mm. Further, the upper curved polarizing plate 10C, the lower curved polarizing plate 20C, and the curved display panel 500C therebetween may have a radius of curvature ranging from one of the numerical values set forth above to another numerical value set forth above.

For example, the upper curved polarizing plate 10C, the lower curved polarizing plate 20C, and the curved display panel 500C therebetween may have a radius of curvature of 2,000 mm to 6,000 mm, or 2,500 mm to 5,200 mm.

Furthermore, the curved display panel 500C may have a height of curvature about 2 mm to about 20 mm, for example, about 3 mm to about 16 mm, or about 3.3 mm to about 15.8 mm. The height of curvature refers to a height from a reference point to an apex of a curved surface when both ends of a cross-section of the curved display panel 500C are defined as the reference point.

Within the ranges of radius of curvature and height of curvature as set forth above, the polarizing plates can secure a high degree of polarization and CR, without being limited thereto.

The curved display panel 500C may include a liquid crystal cell. The liquid crystal cell may typically include two substrates and a liquid crystal layer interposed between the substrates. Generally, a color filter, facing electrodes, and an alignment layer may be formed on one of the substrates, and a liquid crystal driving electrode, a wiring pattern, a thin film transistor device, an alignment layer, and the like may be formed on the other substrate.

An operation mode of the liquid crystal cell may include, for example, a twisted nematic mode, and an electrically controlled birefringence mode. The electrically controlled birefringence mode may include a vertical alignment mode, an optically compensated bend (OCB) mode, an in-plane switching (IPS) mode, and the like.

In addition, although not shown in the drawings, a backlight unit including a light source may be disposed on a lower side of the lower curved polarizing plate 20C. The backlight unit may generally include the light source, a light guide plate, a reflective film, and the like. Backlight units may be arbitrarily divided into direct type, side light type, surface light source type backlight units, and the like. Since the backlight units are widely known in the art, more details thereof are omitted.

### EXAMPLES

Next, the constitution and effects of the present invention will be described in more detail with reference to some examples. It should be understood that these examples are provided for illustration only and are not to be construed in any way as limiting the present invention.

Some detailed descriptions can be omitted in these examples. It can be inferred technical analogy by a person skilled in the art.

### Examples 1 to 3 and Comparative Examples 1 and 2

A difference between machine-direction and transverse-direction shrinkages of polarizing plates was adjusted as listed in Table 1, followed by arranging the polarizing plates on upper and lower sides of a flat display panel, respectively, such that machine directions of the polarizing plates were orthogonal to each other. In addition, the polarizing plate on the upper side of the display panel had a greater machine-direction length than a transverse-direction length. Each shrinkage was measured using an IM-6600 (Keyence Co., Ltd.), and a 0.5 mm thick alkali-free glass substrate was used as each substrate constituting the display panel. Here, a polarizer protective film of the polarizing plates had an in-plane retardation (Re) of 8,300 nm and an out-of-plane retardation (Rth) of 9,600 nm.

### Experimental Example

Height of curvature, radius of curvature, degree of polarization after formation of a curved surface, and color ratio (CR) after formation of a curved surface were measured on each of the curved glass substrates obtained in Examples 1 to 3 and Comparative Examples 1 and 2, and results are shown in Table 1. The degree of polarization was measured using a V-7100 (Jasco Co., Ltd.), and the CR was measured in accordance with VESSA standards using a spectroradiometer (SR-3A, TOPCON Co., Ltd.). The height of curvature of the glass substrate was measured using Vernier calipers and the radius of curvature of the glass substrate was calculated using a circle formed by the lowest height of curvature among measured height of curvatures.

TABLE 1

| | Difference | | | | |
|---|---|---|---|---|---|
| | between | | | | |
| | machine- | | | | |
| | direction and | | | | |
| | transverse- | | | Degree | |
| | direction | Height | Radius | of | |
| | shrinkages of | of | of | polar- | |
| | polarizing plate | curvature | curvature | ization | |
| | (%, MD-TD) | (mm) | (mm) | (%) | CR |
| Example 1 | 3.6 | 3.3 | ϕ 5,200 | 99.9945 | 5,120 |
| Example 2 | 7.4 | 6.5 | ϕ 4,200 | 99.9965 | 5,255 |
| Example 3 | 17.6 | 15.8 | ϕ 2,500 | 99.9985 | 5,680 |
| Comparative | 2.1 | 1.8 | ϕ 6,500 | 99.9402 | 4,945 |
| Example 1 | | | | | |
| Comparative | 0.4 | 0.2 | ϕ 12,000 | 99.9894 | 4,622 |
| Example 2 | | | | | |

It was confirmed that the display panel could have a curved surface by adjusting the machine-direction and transverse-direction shrinkages of the polarizing plate as in the present invention even without a separate curved surface forming process. In addition, it was confirmed that, when the range of shrinkage difference according to the present invention was satisfied, the polarizing plate could secure excellent degree of polarization and CR while the curved display panel could be formed. On the other hand, it could be confirmed that, although the display panels of Comparative Examples 1 and 2 had a certain degree of curvature, the polarizing plates of Comparative Examples 1 and 2 had low degree of polarization and low CR.

It should be understood that the foregoing embodiments are provided for illustration only and different embodiments can be applied in combination.

1. A polarizing plate comprising:
a polarizer; and
a polarizer protective film disposed on at least one surface of the polarizer,
wherein the polarizing plate has machine-direction (MD) shrinkage that is greater than transverse-direction (TD) shrinkage by about 2.2% to about 20%.

2. The polarizing plate according to claim 1, wherein the machine direction is an absorption axis of the polarizer.

3. The polarizing plate according to claim 1, wherein the polarizer protective film comprises a polyester material.

4. The polarizing plate according to claim 3, wherein the polarizer protective film comprises polyethylene terephthalate, polyethylene naphthalate, or a copolymer including combinations thereof.

5. The polarizing plate according to claim 4, wherein the polarizer protective film has a triple co-extrusion structure comprising polyethylene terephthalate, polyethylene naphthalate, or the copolymer including these materials.

6. The polarizing plate according to claim 1, wherein the polarizing plate has a machine-direction length and a transverse-direction length different from each other.

7. The polarizing plate according to claim 1, wherein the polarizer protective film has an in-plane retardation of about 5,000 nm to about 15,000 nm.

8. A curved liquid crystal display comprising:
a curved display panel displaying images in response to an applied signal;
an upper curved polarizing plate disposed on an upper side of the curved display panel; and
a lower curved polarizing plate disposed on a lower side of the curved display panel,
wherein machine directions (MDs) of the upper and lower curved polarizing plates are orthogonal to each other, and
the upper and lower curved polarizing plates have machine-direction shrinkage that is greater than transverse-direction shrinkage by about 2.2% to about 20%.

9. The curved liquid crystal display according to claim 8, wherein the curved liquid crystal display has a viewer-facing surface, the viewer-facing surface being a curved surface concave with respect to the viewer.

10. The curved liquid crystal display according to claim 9, wherein the upper curved polarizing plate is disposed on the viewer-facing surface with reference to the curved display panel and has a greater machine-direction length than a transverse-direction length.

11. The curved liquid crystal display according to claim 10, wherein the lower curved polarizing plate has a greater transverse-direction length than a machine-direction length.

12. A method of manufacturing a curved liquid crystal display, comprising:
preparing a flat display panel displaying images in response to an applied signal; and
attaching polarizing plates such that an upper polarizing plate is attached to an upper side of the flat display panel and a lower polarizing plate is attached to a lower side of the flat display panel,
wherein machine directions (MDs) of the upper and lower polarizing plates are orthogonal to each other, and
the upper and lower polarizing plates have machine-direction shrinkage that is greater than transverse-direction shrinkage by about 2.2% to about 20%.

13. The method according to claim 12, wherein, by attaching the polarizing plates, the flat display panel is transformed into a curved display panel having a viewer-facing surface, the viewer-facing surface being a curved surface concave with respect to the viewer.

14. The method according to claim 13, wherein, in attaching the polarizing plates, the upper polarizing plate is disposed on the viewer-facing surface with reference to the flat display panel and has a greater machine-direction length than a transverse-direction length.

15. The method according to claim 14, wherein, in attaching the polarizing plates, the lower polarizing plate is disposed on a surface opposite the surface on which the upper polarizing plate is disposed with reference to the flat display panel, and has a greater transverse-direction length than a machine-direction length.
